(19) United States
(12) Patent Application Publication
(10) Pub. No.: US 2018/0298312 A1
(43) Pub. Date: Oct. 18, 2018

(54) PRODUCTION PROCESS OF A BEER CONTAINING A REDUCED CONTENT OF CARBOHYDRATES AND ASSOCIATED BEER

(71) Applicants: Christophe DI POMPEO, Lille (FR); Olivier FOREST, Monceau Saint Waast (FR)

(72) Inventors: Christophe DI POMPEO, Lille (FR); Olivier FOREST, Monceau Saint Waast (FR)

(21) Appl. No.: 15/765,827

(22) PCT Filed: Oct. 6, 2016
(86) PCT No.: PCT/IB2016/055989

§ 371 Date: Apr. 4, 2018

(30) Foreign Application Priority Data
Oct. 7, 2015 (FR) 15/59520

(51) Int. Cl. C12C 12/02; C12C 7/26; C12C 5/00

(52) U.S. Cl. CPC C12C 12/02; C12C 5/004; C12C 7/26

(57) ABSTRACT

A method for producing a beer according to which a wort is prepared by brewing a mixture containing water and the malt of a cereal or a mixture of malts, then after cooling the wort, a yeast is added, selected from Saccharomyces cerevisiae, Saccharomyce carlsbergensis and mixtures thereof. After cooling of the wort, an enzyme is added, selected from the dextrinases and mixtures of dextrinases.

### TECHNICAL FIELD

The present invention relates to a production process of a beer containing a reduced total content of carbohydrates and in particular a reduced content of sugar as well as a beer containing a reduced amount of carbohydrates, in particular of sugars and which may be obtained by said process.

### PRIOR ART

The conventional production process of beer includes 6 steps before bottling.

During the first crushing step, the malt is ground; the content of the grain is crushed and expelled from its husk in order to promote the extraction of natural enzymes from the grain and the starch it contains.

The second step is the mashing which is the first step of the brewing. It consists in soaking and stirring (brewing) the crushed malt in hot water in order to extract the starch contained in the malt. The mixture of crushed malt and water is called mash. During this step, the mash is heated at different temperature ranges. Firstly, the mash is heated during a first stage of about 15 minutes so that the mash reaches a temperature of about 50° C. so that the insoluble complex proteins of the malt are transformed into amino acids, this step is called proteolysis. The proteolysis is due to the action of two enzymes, the proteinase and peptidase, contained in the malt. Then, the mash is heated during a second stage, so that the mash reaches a temperature around 62° C. This stage allows the gelatinization of the starch and its transformation into fermentescible sugars under the action of 5 enzymes, beta amylase, alpha amylase, limit dextrinase, maltase and saccharase. The starch is transformed into sugars, some of which are fermentescible (including dextrins, maltotetraose, maltotriose, maltose, sucrose, glucose and fructose). This step lasts between 30 and 45 minutes. The mash which no longer contains starch is then heated to a temperature between 68° C. and 75° C.; at these temperatures, the alpha amylase contained in the grain takes action during a fermentation reaction in order to transform dextrose and maltose into non-fermentescible sugars (dextrins) which will give body and roundness to beer. This step lasts between 30 and 60 minutes.

The third step is the filtration. The mixture obtained after the brewing step, also called brew is filtered to separate the liquid portion called wort from the exhausted malt residues (husk of the grains and other insoluble particles) which are called the draff. The remaining draff in the tank are then rinsed with water heated to about 76° C. in order to extract therefrom a maximum of sugars which are still present. The rinsing water which contains these sugars is added to the wort.

The fourth step consists in cooking the wort. The wort is brought to boil for 1 to 2 hours. The cooking allows stabilizing and sterilizing the wort, but it is also in this step that the hop (or hops) is added to the wort, it is called hopping. Its role is important, it provides the wort, via the resins thereof, with two acids which sterilize, preserve and give the bitterness to beer. It is generally incorporated for a first time at the beginning of cooking and is added either from time to time or at the end to keep some essential oils of hop. The cooking also allows coagulating the proteins of the malt and promoting the clearness and sterilizing the wort. Other aromatic products may also be added.

The fifth step is the cooling. After boiling, the wort which is still cloudy contains hop and protein residues which decant at the bottom of the tank. It is separated from the solid residues then cooled in order to put it at the ideal temperature for the fermentation.

The aforementioned mashing, filtration, cooking and cooling steps constitute the brewing of the beer.

The sixth step consists in fermenting the wort. The wort, which does not contain starch, is transferred to a fermentation tank and is then pitched with a brewer's yeast. There are 2 fermentation methods: the high fermentation, which takes place at a temperature of about 22° C. and the low fermentation, which takes place at a temperature of about 12° C. A few hours after pitching, the yeast has already been well multiplied. Glucose is transformed into CO₂ and water as a result of the respiration of the yeast which consumes oxygen contained in the mixture. When oxygen is lacking, the yeast then transforms the fermentescible sugars into alcohol and carbon dioxide (anaerobic step). This fermentation called primary fermentation will last between 4 and 8 days then the beer called “green beer” will be transferred to the storage tank to undergo a fermentation called secondary fermentation, for a few weeks at a lower temperature. During this secondary fermentation, the yeasts continue to ferment and transform the remaining fermentescible sugars into alcohol and CO₂ and the solid particles decant at the bottom of the tank which clarifies the beer. Once the secondary fermentation is advanced, the yeast begins to feel the lack of fermentescible materials and goes into dormancy.

The beer which is the liquid phase obtained at the end of the secondary fermentation is then bottled or packaged in kegs or can. For the beers refermented in bottles, a small amount of sugar and yeasts are added in the flat beer then caps are put on the bottles and the bottles are placed in a temperate chamber in order to promote the refermentation. For the conventional beers, CO₂ is injected in the flat beer and right away cap is put on the bottle.

Besides the added sugar and the alcohol, the beer therefore naturally contains, due to its production process, a non-negligible amount of glucids or carbohydrates, including sugars. Beer is a complex mixture of sugars comprising monosaccharides such as glucose and maltose and maltotriose, which may be consumed by yeast and more complex sugars which cannot be consumed by said yeast. It is estimated that a beer obtained according to the aforementioned conventional process may contain up to 12 g/L of carbohydrates. The amount of sugars and the produced type of sugars depend on the used yeast. In the present invention, the term beer refers to a fermented drink obtained by exclusive use of a yeast or a yeast mixture selected from the genus Saccharomyces and more particularly from the species Saccharomyces cerevisiae and Saccharomyces carlsbergensis.

The beer consumption is therefore not without consequence both for people who monitor their caloric intake and people suffering from diabetes.

Therefore, it has been sought to produce a beer which has a lower concentration of sugars.

Thus, the document CA 332104 A describes a production process of a beer called «sugar-free» beer which comprises a step of adding water in order to modify the density of the wheat malt after the proteolysis. The hop is then added and heated to coagulate the albumin coming from the malt. During the fermentation step, the density is also adjusted before adding the yeasts. It is this adjustment of the density which allows reducing the quantity of sugars.

The document EP 1 357 176 A describes a process of a fermented drink which is not a beer within the meaning of the invention. Indeed, the used yeast is a yeast to produce sake or wine. Such yeasts produce sugar mixtures different from those produced by the yeasts of the genus Saccharomices.

The document U.S. Pat. No. 4,355,047 B describes a production process of a beer which comprises the addition of a rice pullulanase and optionally a diastase or a malt beta amylase. The obtained beer has a reduced sugar level and a minimum total carbohydrate content of at least 0.78 g/100 mL, obtained by the combination of pullulanase and malt beta amylase. Pullulanase allows in particular reducing pullulan into maltotriose consumable by the yeast. Beta amylase will also reduce complex sugars by hydrolyzing the beta 1-6 bonds of sugars.

An object of the present invention is to propose a new production process of a beer containing a reduced concentration of carbohydrates, in particular of sugars, relative to a beer obtained according to the aforementioned conventional process.

Another abject of the present invention is to propose a process which allows obtaining a beer whose total content of carbohydrates is lower than that of the beer of the prior art.

Another object of the present invention is to propose a process which allows producing a beer whose total content of carbohydrates is reduced and which is pleasant to drink.

### BRIEF DESCRIPTION OF THE INVENTION

In order to achieve at least one of the aforementioned objects, the present invention proposes a production process of a beer according to which a wort is prepared by brewing a mixture containing water and malt of a cereal or a malt mixture, then after cooling of said wort, a yeast selected from Saccharomyces cerevisiae, Saccharomyces carlsbergensis and mixtures thereof. Characteristically, according to the invention, after cooling said wort, an enzyme selected from dextrinases and dextrinase mixtures is added.

According to the invention, no other yeast is added than those mentioned above and no other enzyme is added than dextrinases. Only one enzyme selected from dextrinases and dextrinase mixtures is added.

Surprisingly, it has been found that the addition of dextrinase(s) would also allow reducing the amount of sugar in the beer. It seems that dextrinases reduce dextrins and probably other sugars contained in the beer, in particular maltose and glucose and probably fructose. Without being related to this explanation, the Applicants explain the considerable drop in the total level of carbohydrates, in particular due to the fact that the maltose, the fructose and the glucose are consumed as a priority by the yeast before the maltotriose. By producing more glucose and maltose thanks to dextrinase, the total concentration of carbohydrates of the beer decreases. The production of maltotriose by rice pullulanase does not allow such a reduction.

Advantageously, said enzyme is added at the same time as said yeast or shortly after the addition of said yeast.

Advantageously, the yeast or the added yeast mixture allows a high temperature fermentation, that is to say a fermentation at a temperature substantially equal to or greater than 18° C. and substantially equal to or less than 30° C. and in particular substantially equal to or less than 26° C. Therefore, we use yeast of the species Saccharomyces cerevisiae.

The carbohydrates that will mainly be transformed are the complex sugars (or complex carbohydrates) which might not be consumed by the yeasts during their respiration or during the anaerobic fermentation reaction. The dextrinase will in particular transform the dextrins into glucose and maltose which will be consumed by the yeast. The fact of increasing the amount of sugars available for the yeast also allows reducing the used amount of malt or using a malt mixture, some of which contain less natural enzymes. The use of a yeast of the genus Saccharomyces cerevisiae allows producing compounds, in particular aldehydes, which give the beer its entire flavor.

### DETAILED DESCRIPTION OF THE INVENTION

Advantageously, gaseous oxygen is added in the wort before the addition of said yeast. This addition of oxygen allows the yeast to multiply. The addition of oxygen may be done, for example, by bubbling air into the wort.

Advantageously, said mixture is cooled to a temperature substantially equal to or greater than 13° C. and substantially equal to or less than 21° C. and in particular substantially equal to 19° C. At this temperature, the yeast will consume the oxygen added in the wort, reproduce and then start the fermentation.

A dextrinase type enzyme or a dextrinase mixture of enzymes and preferably only a dextrinase or a dextrinase mixture is added except for another enzyme type(s). They act exclusively on the dextrins. It is the merit of the Applicants that having found that it is possible to significantly reduce the total content of carbohydrates of the beer by reducing the content of a particular category of sugars while maintaining a drink whose alcohol content is tolerated for a beer (from 2 to 12° and more particularly from 2° to 10° or more particularly from 2° to)8° and which remains pleasant to drink.

According to a particular embodiment of the brewing step:
heating a mixture of water and at least a malt of a cereal with a first stage at a temperature substantially equal to or greater than 45° C. and substantially equal to or less than 55° C., in particular substantially equal to 50° C. for a duration substantially equal to or greater than 10 minutes and substantially equal to or less than 20 min, in particular substantially equal to 15 minutes, in order to carry out the proteolysis;
heating during a second stage at a temperature substantially equal to or greater than 68° C. and substantially equal to or less than 75° C., in particular substantially equal to 72° C., to promote the action of the alpha amylases;
filtering said obtained mixture and possibly rinsing the obtained draff;
bringing the liquid phase obtained by filtration to boil for a duration substantially equal to or greater than 1 hour and substantially equal to or less than 3 hours, preferably substantially equal to 2 hours, by possibly adding hops in one or more time(s) during said boiling.

According to a particular embodiment, after said first stage, said mixture is heated during an intermediate stage at a temperature greater than or equal to 62° C. and less than or equal to 63° C. and that possibly said mixture is filtered without carrying out said second heating stage. This intermediate stage may possibly replace the second stage.

According to an embodiment, we check that the wort obtained after boiling no longer contains starch. This step may be implemented, for example with an assay with iodinated water.

According to an embodiment which may be combined with any one of those mentioned above, the pH of the wort obtained after cooling and before the addition of yeast(s) is maintained at a value substantially equal to or greater than 4.5 and substantially equal to or less than 6.5 and preferably at a value substantially equal to 5.2. During the fermentation of the yeast, the pH is maintained at a value substantially equal to or greater than 4 and substantially equal to or less than 5. Such a pH promotes the action of the added enzymes in particular dextrinases.

According to an embodiment which may be combined with any one of the aforementioned embodiments, said mixture obtained after cooling and adding of said enzyme and said yeast is left to ferment and the temperature of said mixture undergoing the fermentation is allowed to reach a value substantially equal to or greater than 20° C. and substantially equal to or less than 30° C. and in particular substantially equal to 24° C. This exothermic fermentation also allows promoting the action of the enzymes, in particular the dextrinases.

Advantageously, said mixture is left to ferment for a duration substantially equal to or greater than 1 day and substantially equal to or less than 10 days and in particular a duration substantially equal to 7 days. This duration allows reducing the sugar content of the beer.

It is also possible to further ferment said mixture a second time for a duration substantially equal to or greater than 7 days and substantially equal to or less than 20 days and in particular substantially equal to 15 days at a temperature substantially equal to or greater than 0° C. The temperature of 0° C. allows the decantation of the yeasts and that of polyphenols and anthocyanogens which are associated with high molecular weight proteins: the beer is clarified.

The amount of enzymes is not limited according to the invention. The Man skilled in the Art is capable of determining the concentration in order to regulate the content of sugar and in particular of remaining dextrins in the beer. Thus, for example, the Applicants have found that at least one dextrinase or a mixture of dextrinases may be added in an amount such that the concentration of added dextrinase(s) is substantially equal to or greater than 5 g/100 L and substantially equal to or less than 30 g/100 L and in particular substantially equal to 10 g/100 L.

According to an embodiment which may be combined with any one of those mentioned above, a given amount of yeast is added allowing obtaining a yeast concentration in the wort substantially equal to or greater than 15,000,000 yeast cells per cm³ of wort.

Advantageously, the yeast(s) is/are allowed to multiply in order to obtain a yeast cell concentration substantially equal to or greater than 45,000,000 yeast cells per cm³ before the beginning of fermentation.

The invention is not limited to a particular malt or a particular malt mixture. Thus, said malt may be selected from the barley malt, the wheat malt, the sorghum malt and the mixtures of at least two of these malts. It is also possible to add raw grains of rice and/or corn, possibly mixed with the barley malt. The malt should preferably contain enough natural enzymes for a brewing without addition of enzyme(s).

It is also possible, according to the invention to add before bottling an additive selected from the flavors, the natural or artificial sweeteners, the gelling agents (gelatin or carrageenan, for example), the pH adjusters, the pre-isomerized hops and/or the foaming agents.

It is also possible to add during the bottling (in particular before the bottling and after the second fermentation) at least one monosaccharide capable of being consumed by the fermentation of the yeast. This addition will not increase the sugar level because the enzymes added to the wort remain active.

The present invention also concerns a beer which contains a total concentration of carbohydrates substantially equal to or less than 0.2 g/100 mL and in particular substantially equal to 0.17 g/100 mL.

### DEFINITIONS

The term «consume» and all affiliated terms refer to the disappearance is of a compound due to a chemical reaction induced by the yeast, whether this reaction is due either to the respiration of the yeast or the fermentation thereof. The term «carbohydrate» refers to any organic compound containing a carbonyl group (aldehyde or ketone) and at least two hydroxyl groups (—OH). The term «carbohydrate» therefore encompasses simple carbohydrates or monosaccharides, such as glucose, saccharose, lactose, fructose, sorbitol and mannose and the complex carbohydrates or complex sugars, such as, in particular, glycogen, starch and cellulose. With reference to the wort obtained by brewing, the term «carbohydrate» refers to a mixture of maltose, at least one of the aforementioned simple carbohydrates except for lactose and cellulose. Indeed, conventionally, a wort comprises 40% by weight of maltose, 10% by weight of the aforementioned simple carbohydrates (mixture of monosaccharides) and 50% of complex carbohydrates, including dextrins and residual cellulose. However, the wort contains no more starch.

The total amount of carbohydrates of the beer is measured according to the method EBC 9.26 by spectrophotometry.

The term «sugar» refers to any compound selected from oses, osides including starchy and non-starchy polysaccharides, homosaccharides and hetero saccharides. We can mention non-limiting examples of sugar, the dextrins including maltodextrin, saccharose, maltose, glucose, fructose, maltotetraose, maltotriose and sucrose.

According to the invention, an enzyme of the dextrinase type is an enzyme which is capable of catalyzing the transformation of the dextrins into glucose and maltose, in particular by hydrolysis of the glycosidic bonds alpha 1-4 and alpha 1-6.

### EXAMPLE

550 kg of Pilsen-type rank malt 2 having a degree of coloration 4 are crushed. The malt should preferably contain enough natural enzymes for a brewing without addition of enzyme(s). The use of malted barley facilitates the filtering: indeed, the barley keeps its straw to the threshing. The product obtained by crushing contains 15% of flour, 65% of groats and the remainder of straw, which allows having a filtering material.

The malt is mixed with water at 98° C. to bring the mixture up to 50° C. while stirring it so as to carry out the proteolysis of the malt. Water at 98° C. is then added to the mash accordingly formed so that the temperature of the mash rises up to 63° C. during an intermediate stage to promote the action of the beta amylases. This step is implemented by the method called infusion method (the malt infusing in water) so as to promote the degradation of starch into sugars. More water at 98° C. is added so that the mash reaches a temperature of 72° C. which promotes the action of the alpha amylases contained in the malt. 4 L of water per Kg of malt are used. The mixture is filtered. The absence of starch is checked by an assay with iodinated water. The liquid phase obtained by filtration is boiled for 2 hours which causes the coagulation of high molecular weight proteins. During these two hours of boiling, 2640 g of hop are added. The wort accordingly obtained is cooled by means of a heat exchanger up to 19° C. 11 liters of doughy brewer's yeasts of Saccharomyce cerevisiae strain are then added. Dextrinases (Endozym®AGP 120) are also added so that their concentration is equal to 10 g per 100 L of the mixture. The beer accordingly obtained is fermented for 7 days at 24° C. without heat supply because the fermentation is exothermic. The beer is then put into cold storage for 15 days at 0° C. After 15 days, it is bottled and 1 g of at least a monosaccharide is added thereto, capable of being consumed during the fermentation of the yeast, per 100 ml of beer. This monosaccharide may be saccharose, maltose or glucose, for example. The beer is placed in a fermentation chamber at 24° C. for 15 days. This allows the foaming and may further reduce the sugar level because the added enzymes are still active.

### ANALYSIS OF THE BEER

0.75 L of the beer accordingly obtained have been analyzed.

The total content of carbohydrates is 0.17 g per 100 ml measured by the method 9.26 EBC (European Brassery Convention). The pH is 3.99. The energy value is 39 Kcal per 100 g. The degree of alcohol is 6.19°.

1. A production process of a beer according to which a wort is prepared by brewing a mixture containing water and malt of a cereal or a malt mixture, then after cooling of said wort, a yeast selected from Saccharomyces cerevisiae, Saccharomyces carlsbergensis and mixtures thereof is added, wherein, after cooling said wort, an enzyme selected from the dextrinases and dextrinase mixtures is added.

2. The process according to claim 1, wherein said mixture is cooled to a temperature substantially equal to or greater than 13° C. and substantially equal to or less than 21° C. and in particular substantially equal to 19° C.

3. The process according to claim 1, wherein said mixture of water and malt(s) is brewed by:
heating said mixture with a first stage at a temperature substantially equal to or greater than 45° C. and substantially equal to or less than 55° C., in particular substantially equal to 50° C. for a duration substantially equal to or greater than 10 minutes and substantially equal to or less than 20 min, in particular substantially equal to 15 minutes, in order to carry out the proteolysis;
heating during a second stage at a temperature substantially equal to or greater than 68° C. and substantially equal to or less than 75° C., in particular substantially equal to 72° C., to promote the action of the alpha amylases;
filtering said obtained mixture and possibly rinsing the obtained draff; and
bringing the liquid phase obtained by filtration to boil for a duration substantially equal to or greater than 1 hour and substantially equal to or less than 3 hours, preferably substantially equal to 2 hours, by possibly adding hop in one or more time(s) during said boiling.

4. The process according to claim 3, wherein, after said first stage, said mixture is heated during an intermediate stage at a temperature greater than or equal to 62° C. and less than or equal to 63° C. and that possibly said mixture is filtered without carrying out said second heating stage.

5. The process according to claim 1, wherein the pH of the mixture obtained after cooling is maintained at a value substantially equal to or greater than 4.5 and substantially equal to or less than 6.5 and preferably at a value substantially equal to 5.2.

6. The process according to claim 1, wherein said mixture obtained after cooling and addition of said enzyme and said yeast is left to ferment and in that the temperature of said mixture during fermentation is allowed to reach a value substantially equal to or greater than 20° C. and substantially equal to or less than 30° C. and in particular substantially equal to 24° C.

7. The process according to claim 6, wherein said adapted yeast is selected from the yeasts of the species Saccharomyces cerevisiae.

8. The process according to claim 1, wherein said mixture is further fermented a second time for a duration substantially equal to or greater than 7 days and substantially equal to or less than 20 days and in particular substantially equal to 15 days at a temperature substantially equal to or greater than 0° C.

9. The process according to claim 1, wherein said dextrinase is added in a given amount such that the concentration of added dextrinase(s) is substantially equal to or greater than 5 g/100 L and substantially equal to or less than 30 g/100 L and in particular substantially equal to 10 g/100 L.

10. The process according to claim 1, wherein said malt is selected from the barley malt, the wheat malt, the sorghum malt and the mixtures of at least two of these malts.

11. The process according to claim 1, wherein, during the bottling, at least a monosaccharide capable of being consumed by the fermentation of the yeast is added.

12. A beer which can be obtained according to the process according to claim 1, containing a total concentration of carbohydrates substantially equal to or less than 0.2 g/100 mL and in particular substantially equal to 0.17 g/100 mL.
